(19) United States
(12) Patent Application Publication
(10) Pub. No.: US 2011/0238819 A1
(43) Pub. Date: Sep. 29, 2011

(54) APPARATUS AND METHOD FOR TRANSMITTING INFORMATION ON AN OPERATIONAL STATE OF THE SAME

(75) Inventors: Kouya Fukagawa, Kawasaki (JP); Masahiro Ohsugi, Kawasaki (JP); Masahiro Ichimi, Kawasaki (JP)

(73) Assignee: FUJITSU LIMITED, Kawasaki-shi (JP)

(21) Appl. No.: 13/039,768

(22) Filed: Mar. 3, 2011

(30) Foreign Application Priority Data
Mar. 26, 2010 (JP) 2010-073753

(51) Int. Cl. G06F 15/173

(52) U.S. Cl. 709/224

(57) ABSTRACT

A communication apparatus acquires current load information including at least one current load value each indicating magnitude of a type of load that is currently imposed on the communication apparatus. A monitoring terminal transmits, to the communication apparatus, a request signal for acquiring an operational state of the communication apparatus. The communication apparatus determines a usable transmission method that is to be used for receiving the request signal and transmitting information on the operational state of the communication apparatus, based on the acquired current load information, and notifies the monitoring terminal about the determined usable transmission method. The monitoring terminal transmits the request signal to the communication apparatus using the usable transmission method notified by the communication apparatus. Then, the communication apparatus transmits information on the operational state of the communication apparatus to the monitoring terminal using the usable transmission method.

### CROSS-REFERENCE TO RELATED APPLICATION

This application is based upon and claims the benefit of priority of the prior Japanese Patent Application No. 2010-073753, filed on Mar. 26, 2010, the entire contents of which are incorporated herein by reference.

### FIELD

The present invention relates to an apparatus and method for transmitting information on an operational state of the apparatus.

### BACKGROUND

In these latter days, remote monitoring systems for remotely monitoring an operational state of a communication apparatus, such as an Operation and Maintenance (O&M) system for a base station conforming to Long Term Evolution (LTE), have been under consideration. As a remote monitoring system, for example, a thin client system may be employed. In the thin client system, a client serving as a monitoring terminal is burdened with a minimum amount of processing whereas a larger amount of processing is concentrated on a server serving as a target to be monitored. This allows the monitoring terminal to be operated by maintenance-free software, thereby increasing maintainability.

Further, with increasing transmission speed of a radio communication in these days, a communication area covered by a single base station has become narrower, thereby increasing the number of base stations to be installed. This raises an issue of increase in the number of monitoring terminals that monitor the installed base stations. As a countermeasure against the above issue, a method has been investigated in which a large number of base stations are monitored at low cost by applying a thin client method to a remote monitoring system.

When applying a thin client method to the remote monitoring system, it may be difficult to monitor, in real time, an operational state of a server to be monitored since an access to the server is performed at the initiative of the monitoring terminal operated by a client. Further, in proportion to the number of monitoring terminals that are logging in the server for the purpose of monitoring an operational state of the server, the utilization rate of a memory or a CPU (Central Processing Unit) that may be caused by a CGI (Common Gateway Interface) or other processes in the server, may become larger.

Transmission methods for monitoring an operational state of the server, for example, include a Polling method, a Long polling method, and a Chunk method. In the polling method, a monitoring terminal operated by a client inquires of a server to be monitored, at regular intervals (polling), about whether a fault event has occurred in the server or not.

In the long polling method, a monitoring terminal operated by a client holds up inquiry about a fault event (polling) until receiving a notification from a server. In the chunk method, a server notifies a monitoring terminal of a fault event while maintaining the connection that has been established by a request signal transmitted from the monitoring terminal to the server.

Japanese Laid-open Patent Publication No. 2006-155505 discloses a method in which a server device acquires status information of a monitoring terminal and schedules the intervals of transmitting a response based on a degree of load being imposed on the monitoring terminal.

However, an appropriate method for monitoring a server device may vary depending on, for example, the number of monitoring terminals that monitor the server device or a priority level assigned to the monitoring terminal. Therefore, in the above related arts, because an appropriate method for monitoring a server device is not selected in consideration of the characteristics of monitoring terminals, there may be a problem that the monitoring of the server device by the monitoring terminals may not be performed effectively.

For example, in the polling method, with increasing time intervals of transmitting a request signal (polling), a time-lag from an occurrence of a fault event until transmission of event information on the fault event to the monitoring terminal may also increase, thereby impairing real-time efficiency. Meanwhile, with decreasing time intervals of transmitting a request signal (polling), processing load of the server or the network may increase regardless of a fault occurrence.

In the long polling method or the chunk method, since a server device or a network has a tendency to undergo a large amount of processing load, the server device may fall into the breakdown of communication when the server device is monitored at the same instant by a large number of monitoring terminals. In this case, for example, some monitoring terminals may determine that the server device has stopped the operation thereof.

### SUMMARY

According to an aspect of an embodiment, there is provided apparatus and method for monitoring an operational state of the apparatus. A communication apparatus is provided with one or more transmission methods, and acquires current load information including at least one current load value each indicating magnitude of a type of load that is currently imposed on the communication apparatus. The communication apparatus determines a usable transmission method that is to be used for receiving a request signal and transmitting information on the operational state of the apparatus, based on the acquired current load information, and notifies the monitoring terminal about the determined usable transmission method. The communication apparatus receives the request signal from the monitoring terminal, using the determined usable transmission method, and transmits information on the operational state of the communication apparatus to the monitoring terminal using the determined usable transmission method, after receiving the request signal from the monitoring terminal.

The object and advantages of the invention will be realized and attained by means of the elements and combinations particularly pointed out in the claims.

It is to be understood that both the foregoing general description and following detailed description are exemplary and explanatory and are not restrictive of the invention, as claimed.

### BRIEF DESCRIPTION OF DRAWINGS

FIG. 1 is a diagram illustrating an example of a communication system, according to an embodiment;

FIG. 2 is a diagram illustrating an example of an association table for storing information associating load information with one or more transmission methods, according to an embodiment;

FIG. 3 is a diagram illustrating an example of an operational flowchart of a controller, according to an embodiment;

FIGS. 4A, 4B are diagrams illustrating an example of an operational flowchart for determining a usable transmission method that is to be used in a congested state, according to an embodiment;

FIGS. 5A, 5B are diagrams illustrating an example of an operational flowchart for determining a usable transmission method that is to be used in a noncongested state, according to an embodiment;

FIG. 6 is a diagram illustrating an example of a transmission sequence for monitoring operations performed using a polling method, according to an embodiment;

FIG. 7 is a diagram illustrating an example of a transmission sequence for monitoring operations performed using a long polling method, according to an embodiment;

FIG. 8 is a diagram illustrating an example of a transmission sequence for monitoring operations performed using a chunk method, according to an embodiment; and

FIGS. 9A, 9B are diagrams illustrating an example of a transmission sequence for monitoring operations performed in a communication system, according to an embodiment.

### DESCRIPTION OF EMBODIMENTS

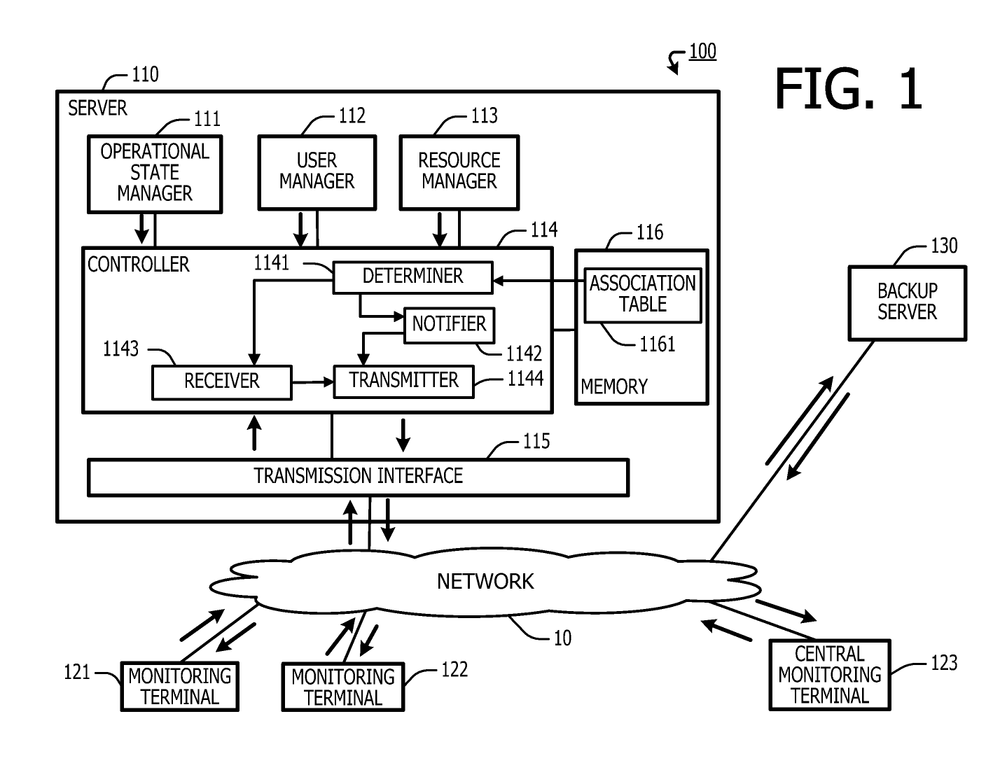

FIG. 1 is a diagram illustrating an example of a communication system, according to an embodiment. As depicted in FIG. 1, communication system 100 according to the embodiment, for example, includes server 110, monitoring terminals 121, 122, central monitoring terminal 123, and backup server 130. Here, it is assumed that each of monitoring terminals 121, 122 is a first type of monitoring terminal, and central monitoring terminal 123 is a second type of monitoring terminal different from the first type of monitoring terminal. In communication system 100, server 110 is a communication apparatus to be monitored, and an operational state of server 110 is monitored by monitoring terminals 121, 122, and central monitoring terminal 123.

Server 110 may be, for example, configured to be a radio base station that performs a radio communication with a mobile station. For example, the radio base station may be an eNB (evolved Node-B) conforming to a LTE. Server 110 may performs, for example, HTTP (HyperText Transfer Protocol) communication using a Web-based client-server method, in which server 110 functions as a server, and monitoring terminals 121, 122 and central monitoring terminal 123 function as clients.

After receiving a request signal from monitoring terminals 121, 122 or central monitoring terminal 123, server 110 transmits information on an operational state of server 110 to monitoring terminals 121, 122, and central monitoring terminal 123. Server 110 may be configured to include, for example, operational state manager 111, user manager 112, resource manager 113, controller 114, and transmission interface 115.

Operational state manager 111 may be configured to acquire information on an operational state of server 110. In the case, description will be given of event information regarding a fault occurrence in server 110, as a representative example of information on an operational state of server 110. For example, upon detecting a fault event in server 110, such as a fault occurrence or a recovery from a fault occurrence, operational state manager 111 sends, as information on the operational state of server 110, event information indicating the fault event to controller 114.

User manager 112 may be configured to manage information on users for whom services are provided by server 110 (for example, the number of the users). In the case, user manager 112 may be configured to manage information on monitoring terminals (for example, monitoring terminals 121, 122, and central monitoring terminal 123) that are logging in server 110. For example, information on priorities assigned to monitoring terminals that are logging in server 110 may be managed in such a way that user manager 112 sets priority to a monitoring terminal based on the type of the monitoring terminal when the monitoring terminal logins server 110. In this case, central monitoring terminal 123 may be set at a priority level higher than those assigned to monitoring terminals 121, 122.

Resource manager 113 may be configured to acquire current load information indicating magnitude of load currently being imposed on server 110. The current load information may include at least one current load value each indicating magnitude of a type of load that is currently imposed on the server 110. For example, the current load information include, as a first type of load, a utilization ratio of CPU that indicates a ratio of the duration time during which software is occupying the CPU to the elapsed time, and/or, as a second type of load, a residential event Q (Queue) count that indicates the number of events that are queuing up in server 110 so as to undergo processing of server 110. Further, current load information may be configured to include, as a type of load, a utilization ratio of memory in server 110 or the amount of communication traffic performed by server 110. Resource manager 113 sends the acquired current load information to controller 114.

Controller 114 may be configured to include, for example, determiner 1141, notifier 1142, receiver 1143, and transmitter 1144.

Determiner 1141 may be configured to determine a usable transmission method by selecting, from among one or more transmission methods, the usable transmission method based on the current load information acquired by the resource manager 113. Here, the usable transmission method is a transmission method used for transmitting a request signal from monitoring terminals 121, 122, or central monitoring terminal 123 to server 110, and for transmitting information on the operational state of server 110 from server 110 to monitoring terminals. A transmission method may be identified by one or more parameters characterizing a difference among the one or more transmission methods. For example, the one or more parameters may be configured to include a request time (RT) defined as a time interval of transmitting a request signal, a request number (RN) defined as the number of times transmitting a request signal, and a connection status (CS) defined as a connection status after transmitting information on the operational state of server 110.

The request time RT is a parameter indicating a time interval at which monitoring terminals 121, 122 and central monitoring terminal 123 transmit a request signal to server 110. The request number RN is a parameter indicating the number of times a monitoring terminal transmits a request signal to server 110. The connection status CS is a parameter indicating a connection status between a monitoring terminal and server 110 after transmitting information on an operational state of server 110 in response to a request signal. For example, the connection status CS indicates whether a connection for monitoring server 110 (hereinafter also referred to as “a monitoring connection) should be disconnected every time information on the operational state of server 110 has been transmitted to a monitoring terminal in response to a request signal from the monitoring terminal.

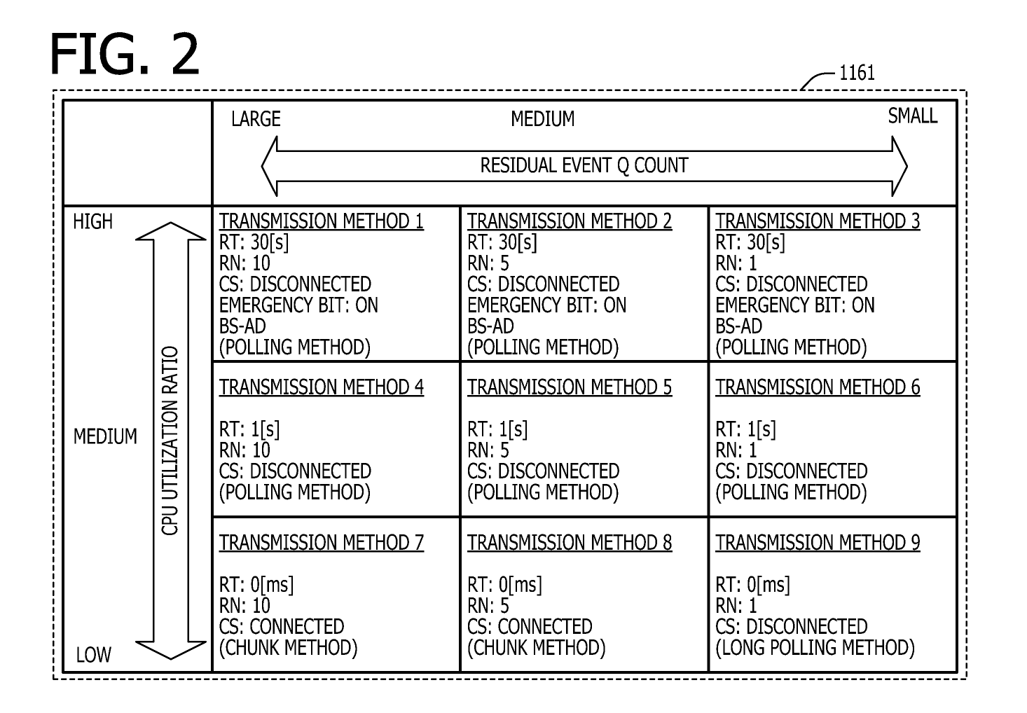

Memory 116 of server 110 may be configured, for example, to store an association table (for example, as depicted in FIG. 2) in which each combination of two types of load information (a CPU utilization ratio and a residual event Q count) is associated with one of one or more transmission methods. Determiner 1141 may be configured to determine a usable transmission method by selecting, from among the one or more transmission methods, a transmission method suitable for the current load of server 110, based on association table 1161 stored in memory 116 of server 110 and current load information received from resource manager 113. It is also possible to configure server 110 such that server 110 stores, in memory 116 thereof, a formula capable of calculating parameters identifying an appropriate transmission method from the current load information. In this case, determiner 1141 may be configured to determine a usable transmission method based on the formula stored in memory 116 of server 110 and the current load information received from resource manager 113.

Notifier 1142 may be configured to notify monitoring terminals 121, 122 or central monitoring terminal 123, about the determined transmission method. For example, notifier 1142 generates creator information indicating the determined transmission method and transmits the generated creator information to monitoring terminals 121, 122 or central monitoring terminal 123 via transmission interface 115.

Receiver 1143 may be configured to receive, via transmission interface 115, a request signal that has been transmitted from monitoring terminals 121, 122 or central monitoring terminal 123 using the usable transmission method determined by determiner 1141. For example, receiver 1143 may be configured to receive a request signal that has been transmitted in the form of a HTTP request message. Transmitter 1144 may be configured to transmit, as information on the operational state of server 110, event information received from resource manager 113 to monitoring terminals 121, 122 or central monitoring terminal 123 via transmission interface 115, using the usable transmission method determined by determiner 1141 in response to the request signal received by receiver 1143. For example, transmitter 1144 may be configured to transmit the event information in the form of a HTTP response message.

Notifier 1142, for example, transmits creator information indicating the determined usable transmission method that is to be used for transmitting subsequent request signals and the event information that is transmitted, as information on the operational state of server 110, in response to the received request signal. It is also possible to configure notifier 1142 to transmit creator information at an arbitrary time regardless of transmission of the event information. In this way, controller 114 may enable monitoring terminals 121, 122 and central monitoring terminal 123 to transmit a request signal using the usable transmission method determined by controller 114, by transmitting creator information to monitoring terminals 121, 122 or central monitoring terminal 123.

Further, controller 114 may be configured to store information on an operational state of server 110, for example, event information, into backup server 130 by transmitting the event information via backup server 130 to central monitoring terminal 123, when magnitude of load currently being imposed on server 110 exceeds a predetermined threshold value (for example, when server 110 falls into a congestion state). Here, the magnitude of load currently being imposed on server 110 may be indicated by the current load information received from resource manager 113. This allows event information (information on the operating state of server 110) to be transmitted to central monitoring terminal 123 even if server 110 is being in a congested state, thereby keeping real-time monitoring of server 110 by central monitoring terminal 123.

Further, notifier 1142 may be configured to transmit creator information in which an emergency bit is set at “ON” and the address information of backup server is stored, to monitoring terminals 121, 122 when the magnitude of load currently being imposed on server 110 exceeds a predetermined threshold value. Here, the emergency bit is information indicating whether server 110 is being in a congested state or not, and when value “ON” is set to an emergency bit, the emergency bit indicates that server 110 is being in a congested state and the destination of a request signal should be switched from server 110 to backup server 130.

This allows backup server 130 to transmit event information (information on the operational state of server 110) in response to a request signal transmitted from monitoring terminals 121, 122, on behalf of server 110 when server 110 has fallen into a congested state, thereby reducing processing load of server 110.

Communication interface 115 is an interface via which server 110 communicates with monitoring terminals 121, 122, central monitoring terminal 123, and backup server 130 through network 10. For example, network 10 may be a wired network or a wireless network, and communication interface 115 is used for performing transmission via wired or wireless connection.

Each of monitoring terminals 121, 122, and central monitoring terminal 123 is a monitoring terminal configured to transmit a request signal to server 110 using the usable transmission method notified by server 110. Further, each of monitoring terminals 121, 122, and central monitoring terminal 123 is configured to receive, as information on an operational state of server 110, event information that has been transmitted from server 110 in response to the request signal transmitted from each monitoring terminal, using the usable transmission method notified by server 110. Each of monitoring terminals 121, 122 may be configured to inform a user about the received event information.

Further, each of monitoring terminals 121, 122 may be configured to inform, upon receiving creator information in which an emergency bit is set at “ON” and the address of backup server 130 is stored, a user about a notification indicating that server 110 is being in a congested state by displaying the notification. Here, for example, when request time RT included in the received creator information is greater than “0[ms]”; each of monitoring terminals 121, 122 suspends transmission of a request signal to server 110 until the request time RT has elapsed.

Further, each of monitoring terminals 121, 122 may be configured to transmit a request signal for acquiring information on an operational state of server 110, to backup server 130 during the time period in which server 110 is being in a congested state. For example, each of monitoring terminals 121, 122 may transmit a request signal to backup server 130 instead of server 110, using, as a destination address of the request signal, the address of backup server 130 that is contained in the received creator information. This allows each of monitoring terminals 121, 122 to receive the event information (information on the operational state) of server 110 without imposing an extra processing load on server 110 that is being in a congested state.

Backup server 130 may be configured to transfer, upon receiving from server 110 event information destined for central monitoring terminal 123, the received event information to central monitoring terminal 123 while storing the received event information in a memory of the backup server 130. Meanwhile, backup server 130, upon receiving a request signal for acquiring information on an operational state of server 110 from monitoring terminals 121, 122, transmits, as information on the operational state of server 110, the stored event information to monitoring terminals 121, 122, respectively. In this way, when server 110 is being in a congested state, backup server 130 may perform transmission of information on an operating state of server 110, on behalf of server 110, in response to the request signal from monitoring terminals 121, 122.

FIG. 2 is a diagram illustrating an example of an association table for storing information associating load information with one or more transmission methods, according to an embodiment. Server 110 may be configured, for example, to store association table 1161 in memory 116 of server 110. In association table 1161, as the load information, for example, each of range combinations of first load ranges and second load ranges is associated with a transmission method to be used when server 110 is being operated under a load condition in which a first current load value is staying within a first load range of the each of the range combinations, and a second current load value is staying within a second load range of the each of the range combinations. Here, each of the first load ranges is a range of a first load value indicating magnitude of a first type of load that is imposable on server 110, and each of the second load ranges is a range of a second load value indicating magnitude of a second type of load that is imposable on server 110. Further, the first and second current load values indicate magnitudes of the first and second types of load that are currently imposed on server 110, respectively. In the example depicted in FIG. 2, a CPU utilization ratio is depicted as the first type of load, and a residual event Q count is depicted as the second type of load.

In the case, the CPU utilization ratio (the first type of load) may be divided into three load ranges: “high”, “medium”, and “low”. For example, determiner 1141 determines that CPU utilization ratio is in a “low” range when the CPU utilization ratio is less than a first threshold value. Determiner 1141 determines that CPU utilization ratio is in a “high” range when the CPU utilization ratio is greater than a second threshold value (that is greater than the first threshold value). Determiner 1141 determines that CPU utilization ratio is in a “medium” range when the CPU utilization ratio is greater than or equal to the first threshold value and less than or equal to the second threshold value.

The residual event Q count (the second type of load) may be divided into three load ranges: “high”, “medium”, and “low”. For example, determiner 1141 determines that a residual event Q count is in a “small” range when the residual event Q count is less than a third threshold value. Determiner 1141 determines that a residual event Q count is in a “large” range when the residual event Q count is greater than a fourth threshold value (that is greater than the third threshold value). Determiner 1141 determines that a residual event Q count is in a “medium” range when the residual event Q count is greater than or equal to the third threshold value and less than or equal to the fourth threshold value.

For example, in association table 1161, transmission method 1 is associated with the range combination of CPU utilization ratio “high” and residual event Q count “large”. Parameters identifying transmission method 1 includes request time RT “30[s]”, request number RN “10”, and connection status CS “disconnected”, meaning that transmission method 1 is a polling method. Here, the parameters identifying transmission method 1 also includes “an emergency bit”, and “BS-AD (Backup Server Address)” indicating the address of backup server 130.

In association table 1161, transmission method 3 is associated with the range combination of CPU utilization ratio “high” and residual event Q count “small”. Parameters identifying transmission method 3 includes request time RT “0[ms]”, request number RN “10”, and connection status CS “connected”, meaning that transmission method 3 is a chunk method.

In association table 1161, transmission method 7 is associated with the range combination of CPU utilization ratio “low” and residual event Q count “large”. Parameters identifying transmission method 7 includes request time RT “0[ms]”, request number RN “10”, and connection status CS “connected”, meaning that transmission method 7 is a chunk method.

Further, in association table 1161, transmission method 9 is associated with the range combination of CPU utilization ratio “low” and residual event Q count “small”. Parameters identifying transmission method 9 includes request time RT “0[ms]”, the number of requests RN “1”, and connection status CS “disconnected”, meaning that transmission method 9 is a long polling method.

Determiner 1141 of Controller 114 may be configured to acquire current load information including two current load values, a CPU utilization ratio (a first current load value) and a residual event Q count (a second current load value), from resource manager 113, and to determine a usable transmission method, by selecting, from association table 1161, one of the one or more transmission methods that is associated with the range combination containing the acquired first and second current load values (the load combination of the CPU utilization ratio and the residual event Q count). Thus, server 110 may determine the usable transmission method, based on current load information that indicates the magnitude of load currently being imposed on server 110. Notifier 1142 of controller 114 generates creator information including parameters identifying the determined usable transmission method, and transmits the generated creator information to monitoring terminals 121, 122 or central monitoring terminal 123.

Further, determiner 1141 of controller 114 may be configured to determine a usable transmission method, based on both current load information of server 110 and a type of a monitoring terminal from which a request signal is transmitted to server 110. In the case, for example, memory 116 may be configured to store one or more association tables 1161 each corresponding to one of types of monitoring terminals. In this case, determiner 1141 determines a usable transmission method by selecting a transmission method associated with a range combination containing the acquired first and second current load values, that is, the acquired pair of the CPU utilization ratio and the residual event Q count, from one of the one or more association tables 1161 that corresponds to the type of the monitoring terminal from which a request signal is transmitted to server 110. This allows determiner 1141 to determine a usable transmission method based on both current load information of server 110 and a type of a monitoring terminal from which a request signal is transmitted to server 110.

Further, when the type of a monitoring terminal is a predetermined specific one (for example, central monitoring terminal 123), determiner 1141 of controller 114 may be configured to determine, as a usable transmission method, a predetermined transmission method whose parameters have been stored beforehand, without using association table 1161. For example, determiner 1141 may be configured to determine a usable transmission method by selecting a long polling method or a chunk method when a monitoring terminal is of a second type, that is, central monitoring terminal 123, thereby improving real-time performance when using central monitoring terminal 123 as a monitoring terminal for server 110.

As described above, association table 1161 stores information associating, as load information, load ranges each indicating a range of a load value, with one or more transmission methods such that the higher is the load value, the smaller is magnitude of load caused by a transmission method associated with one of the load ranges that contains the load value. This allows determiner 1141 to determine a usable transmission method that causes decreasing amount of load on server 110 when the magnitude of load currently imposed on server 110 is increased. As a result, when the magnitude of load currently imposed on server 110 is large, the magnitude of load caused by monitoring server 110 may be reduced.

From another viewpoint, association table 1161 stores information associating load ranges each indicating a range of a load value, with one or more transmission methods such that the smaller is the load value, the higher is the real-time performance of a transmission method associated with one of the load ranges that contains the load value. This allows determiner 1141 to determine a usable transmission method that enhances real-time performance of server 110 when the amount of load currently imposed on server 110 is decreased. As a result, when the amount of current load of server 110 is small, the real-time performance for monitoring server 110 may be enhanced.

Relationship between load information and a transmission method within association table 1161 is not limited to the above mentioned relationship, and may be set with flexibility depending on characteristics of each of transmission methods or an applied area of server 110. In the above example, description has been given of a method in which a usable transmission method is determined based on load information including range combinations of two types of load values: a CPU utilization ratio and a residual event Q count. However, a method for determining a usable transmission method may not be limited to this. For example, determiner 1141 may be configured to determine a usable transmission method based on load information including load ranges of one type of load value, for example, one of a CPU utilization ratio or a residual event Q count. Further, determiner 1141 may be configured to determine a usable transmission method based on other load values different from a CPU utilization ratio or a residual event Q count, for example, based on memory utilization ratio or communication traffic.

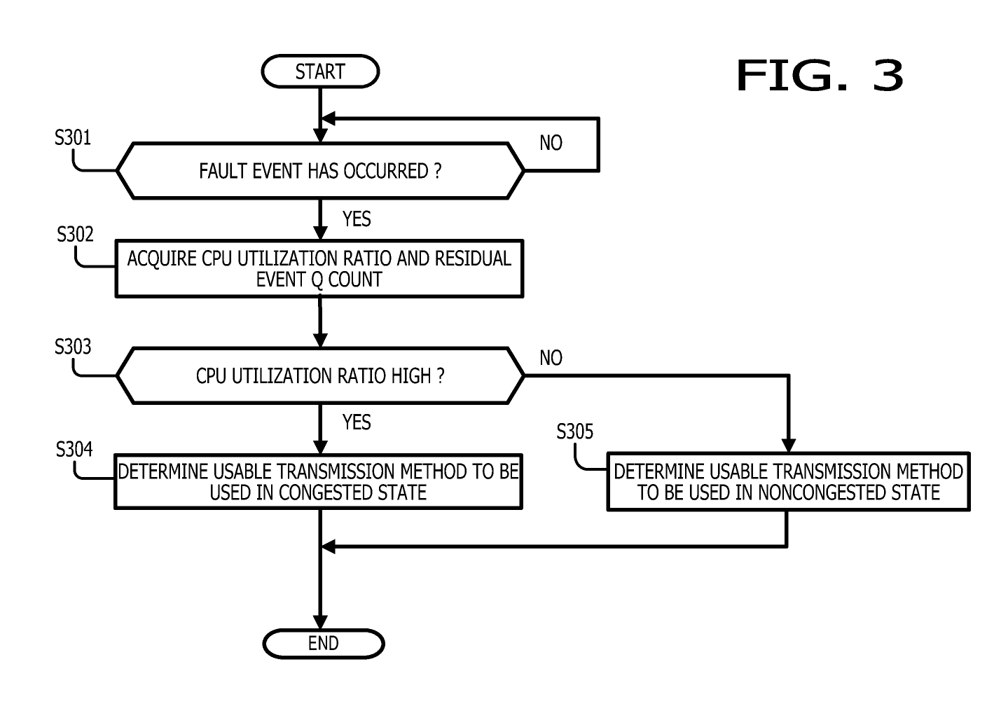

FIG. 3 is a diagram illustrating an example of an operational flowchart of a controller, according to an embodiment. Controller 114 of server 110 performs, for example, the following sequence of operations. First, controller 114 determines whether a fault event has occurred or not in server 110, based on information received from operational state manager 111 (in operation S301), and waits for an occurrence of a fault event (NO in operation S301, looping). When the fault event has occurred (YES in operation S301), controller 114 acquires current load values of server 110, for example, a CPU utilization ratio and a residual event Q count, from resource manager 113 (in operation S302).

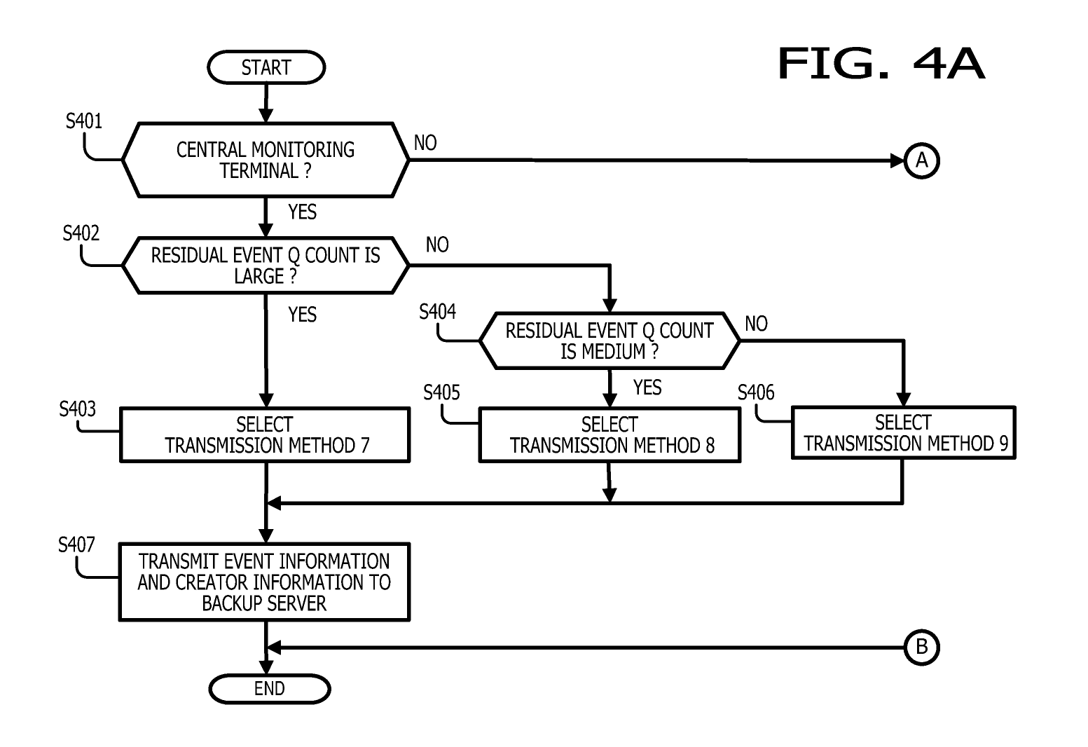

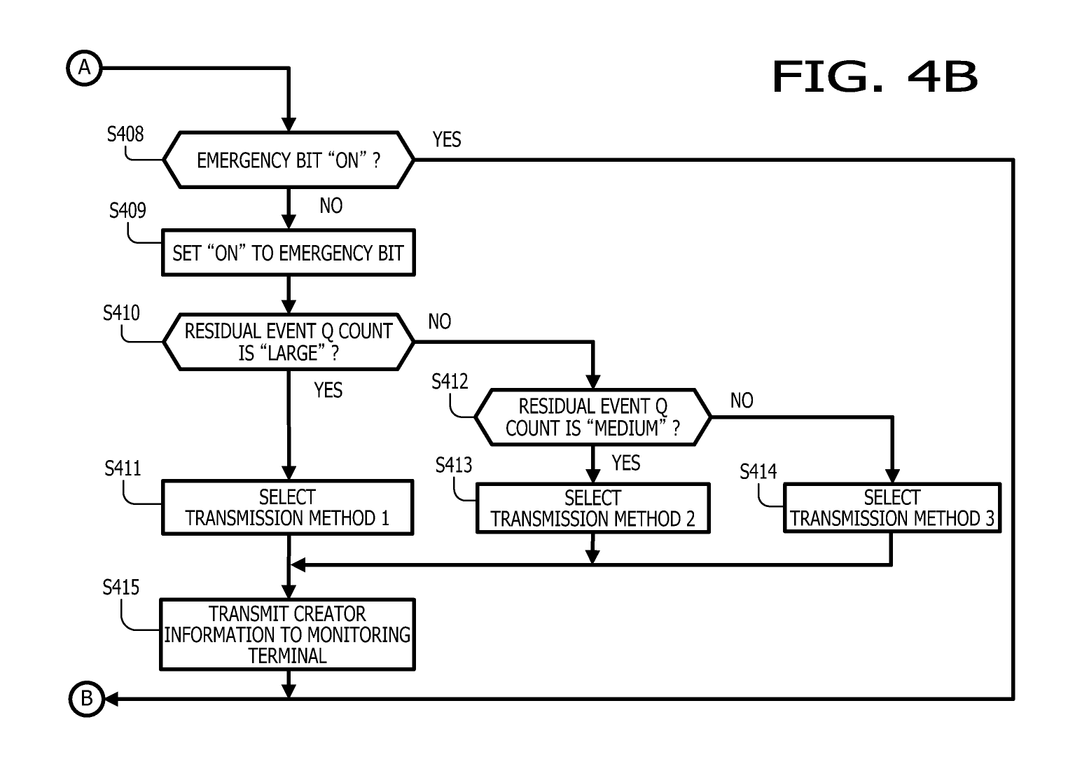

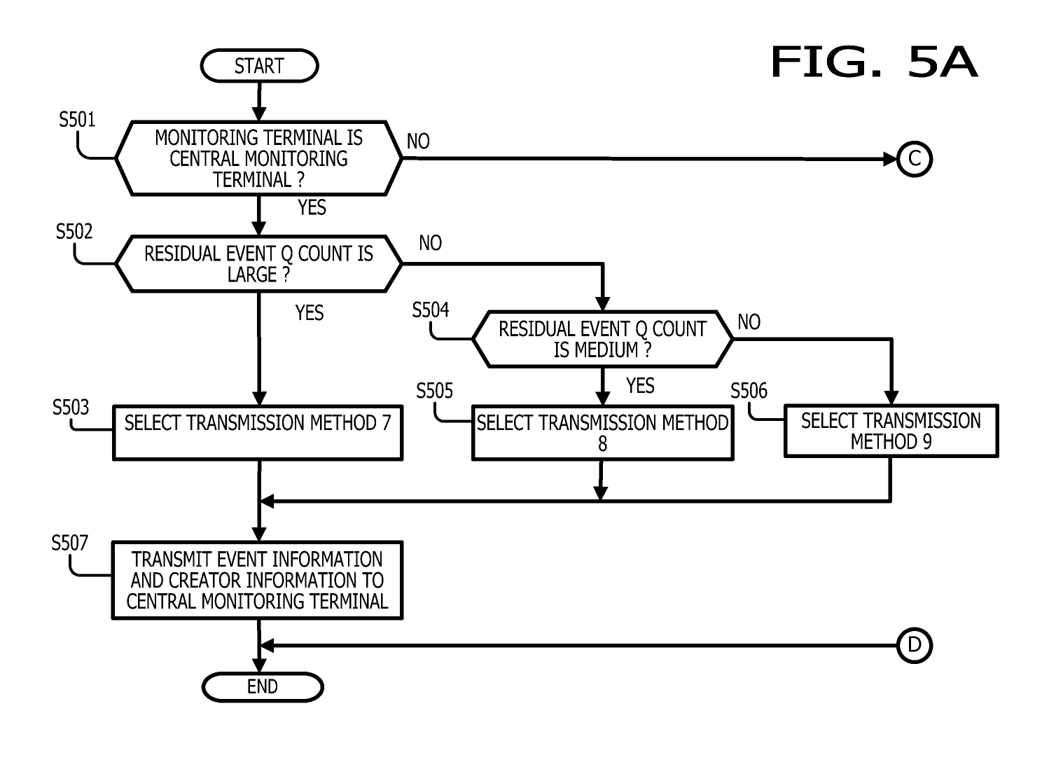

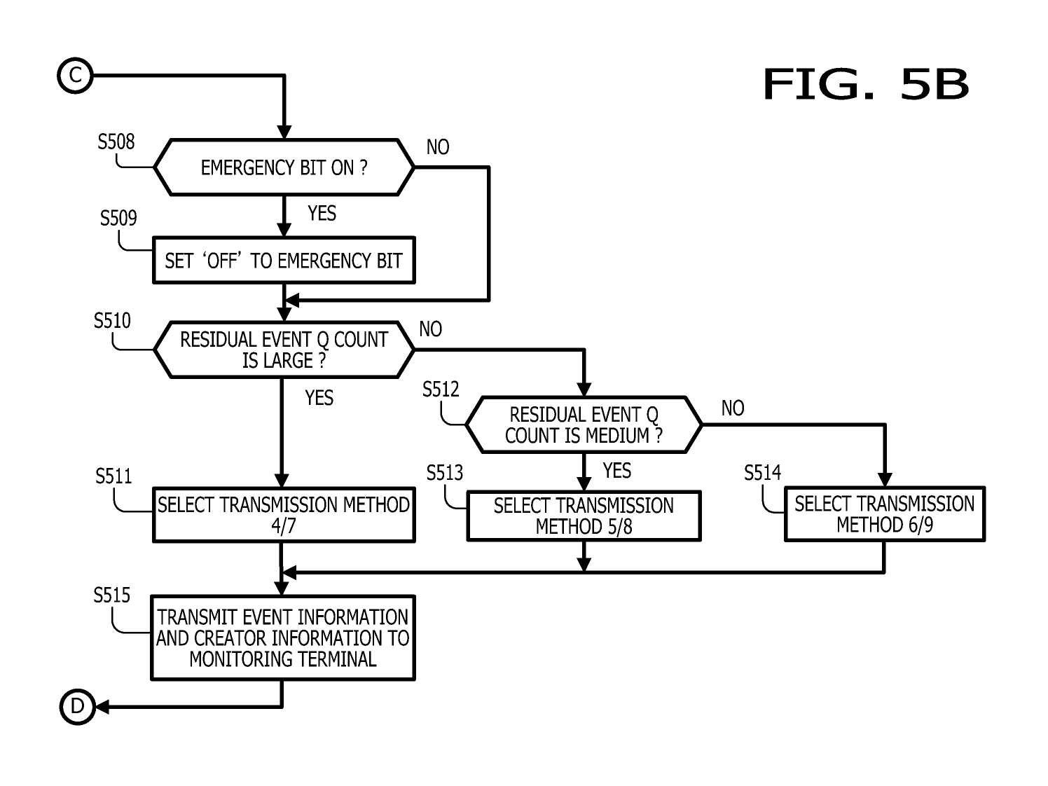

Next, controller 114 determines whether the acquired CPU utilization ratio is “high” or not (in operation S303). When the acquired CPU utilization ratio is “high” (YES in operation S303), controller 114 performs processing (for example, refer to FIGS. 4A, 4B) of determining a usable transmission method that is to be used in a congested state (in operation S304), and terminates the sequence of operations. When the acquired CPU utilization ratio is “medium” or “low” (NO in operation S303), controller 114 performs processing (for example, refer to FIGS. 5A, 5B) of determining a usable transmission method that is to be used in a noncongested state (in operation S305), and terminates the sequence of operations.

FIGS. 4A, 4B are diagrams illustrating an example of an operational flowchart for determining a usable transmission method that is to be used in a congested state, according to an embodiment. Controller 114 of server 110 performs, for example, the following sequence of operations for determining a usable transmission method that is to be used in a congested state, for each of monitoring terminals that are currently logging in server 110. In this case, it is assumed that two types of monitoring terminals are logging in server 110. Here, it is assumed that, as a first type of monitoring terminal, monitoring terminals 121, 122 are logging in server 110, and, as a second type of monitoring terminal, central monitoring terminal 123 is logging in server 110.

First, controller 114 determines the type of an intended monitoring terminal. In this case, controller 114 determines whether an intended monitoring terminal is central monitoring terminal 123 (the second type) or not (in operation S401). When the intended monitoring terminal is central monitoring terminal 123 (YES in operation S401), controller 114 determines whether the residual event Q count acquired in operation S302 of FIG. 3 is “large” or not (in operation S402). When it is determined that the residual event Q count is “large” (YES in operation S402), controller 114 determines a usable transmission method by selecting transmission method 7 from association table 1161 (in operation S403), and shifts to operation S407.

When it is determined that the residual event Q count is not “large” (NO in operation S402), controller 140 determines whether the residual event Q count is “medium” or not (in operation S404). When the residual event Q count is “medium” (YES in operation S404), controller 114 determines a usable transmission method by selecting transmission method 8 from association table 1161 (in operation S405), and shifts to operation S407.

When it is determined that the residual event Q count is not “medium”, that is, “small” (NO in operation S404), controller 114 determines a usable transmission method by selecting transmission method 9 from association table 1161 (in operation S406). Next, controller 114 generates creator information including parameters identifying the usable transmission method selected in one of operations S403, S405, and S406, and transmits event information (information on an operational state od server 110) and the generated creator information to backup server 130 (in operation S407). Then, controller 114 terminates the sequence of operations. Here, the event information transmitted in operation S407 indicates the fault event detected in operation S301 of FIG. 3.

When an intended monitoring terminal is not central monitoring terminal 123 (NO in operation S401), that is, when the intended monitoring terminal is one of monitoring terminals 121, 122 (the first type), controller 114 determines whether an emergency bit stored in memory 116 of server 110 is set at “ON” or not (in operation S408). Here, as mentioned above, the emergency bit is information indicating whether server 110 is being in a congested state or not, and when value “ON” is set to an emergency bit, the emergency bit indicates that server 110 is being in a congested state and the destination of a request signal should be switched from server 110 to backup server 130. Therefore, when the emergency bit is being set at “ON” (YES in operation S408), controller 114 terminates the sequence of operations. In this way, controller 114 is able to suspend transmission of event information and creator information to monitoring terminals 121, 122 when server 110 has fallen into a congested state, thereby reducing processing load of server 110.

When the emergency bit is being set at “OFF” (NO in operation S408), controller 114 sets “ON” to the emergency bit (in operation S409). Next, controller 114 determines whether the residual event Q count acquired in operation S302 of FIG. 3 is “large” or not (in operation S410). When the residual event Q count is “large” (YES in operation S410), controller 114 determine a usable transmission method by selecting transmission method 1 from association table 1161 (in operation 411), and shifts to operation S415.

When it is determined that the residual event Q count is not “large” (NO in operation S410), controller 114 determines whether the residual event Q count is “medium” or not (in operation S412). When the residual event Q count is “medium” (YES in operation S412), controller 114 determines a usable transmission method by selecting transmission method 2 from association table 1161 (in operation S413), and shifts to operation S415.

When it is determined that the residual event Q count is not “medium” (NO in operation S412), that is, it is determined that the residual event Q count is “small”, controller 114 determines a usable transmission method by selecting transmission method 3 from association table 1161 (in operation S414), and shifts to operation S415. Next, controller 114 generates creator information including parameters identifying the usable transmission method that was selected in one of operations S411, S413, and S414, and transmits the generated creator information to the monitoring terminal (in operation S415). Then controller 114 terminates the sequence of operations.

Here, the creator information transmitted in operation S415 includes, as parameters, the emergency bit that has been set at “ON” in operation S409 (as denoted by “EMERGENCY BIT: ON” in FIG. 2) and the address information of backup server 130 (as denoted by “BS-AD” in FIG. 2). This allows monitoring terminals 121, 122 (the first type monitoring terminals) to switch a destination of a request signal from server 110 to backup server 130 when server 110 has fallen into a congested state.

FIGS. 5A, 5B are diagrams illustrating an example of an operational flowchart for determining a usable transmission method that is to be used in a noncongested state, according to an embodiment. Controller 114 of server 110 performs, for example, the following sequence of operations for determining a usable transmission method that is to be used in a noncongested state, for each of monitoring terminals that are logging in server 110. In this case, it is assumed that two types of monitoring terminals are logging in server 110. For example, it is assumed that, as a first type of monitoring terminal, monitoring terminals 121, 122 are logging in server 110, and, as a second type of monitoring terminal, central monitoring terminal 123 is logging in server 110.

In FIG. 5A, operations S501 to S506 may be performed in a manner similar to operations S401 to S406 of FIG. 4A, and the detailed description of operations from S501 to S506 will be omitted here. After performing operations S503, S505, or S506, controller 114 transmits event information and creator information to central monitoring terminal 123 (in operation S507), and terminates the sequence of operations. Here, the event information that is transmitted in operation S507 indicates the fault event that has occurred in operation S301 of FIG. 3, and the creator information transmitted in operation S507 includes parameters identifying the usable transmission method selected in one of operations S503, S505, and S506.

When it is determined that an intended monitoring terminal is not central monitoring terminal 123 (a second type of monitoring terminal) (NO in operation S501), that is, when it is determined that the intended monitoring terminal is one of monitoring terminals 121, 122 (a first type of monitoring terminal), controller 114 determines whether the emergency bit stored in memory 116 of server 110 is being set at “ON” or not (in operation S508). When the emergency bit is not being set at “ON” (NO in operation S508), that is, when the emergency bit is set at “OFF”, controller 114 shifts to operation S510. Meanwhile, when the emergency bit is being set at “ON” (YES in operation S508), controller 114 sets “OFF” to the emergency bit (in operation S509).

Next, controller 114 determines whether the residual event Q count acquired in operation S302 of FIG. 3 is “large” or not (in operation S510). When the residual event Q count is determined to be “large” (YES in operation S510), controller 114 determine a usable transmission method by selecting transmission method 4 from association table 1161 when the CPU utilization ratio obtained in operation S302 of FIG. 3 is “medium”, or by selecting transmission method 7 from association table 1161 when the CPU utilization ratio is “low” (in operation S511).

When it is determined that the residual event Q count is not “large” (NO in operation S510), controller 114 determines whether the residual event Q count is “medium” or not (in operation S512). When the residual event Q count is “medium” (YES in operation S512), controller 114 determines a usable transmission method by selecting transmission method 5 from association table 1161 when the CPU utilization ratio obtained in operation S302 of FIG. 3 is “medium”, or by selecting transmission method 8 from association table 1161 when the CPU utilization ratio is “low” (in operation S513). Then, controller 114 shifts to operation S515.

When it is determined that the residual event Q count is not “medium” (NO in operation S512), that is, it is determined that the residual event Q count is “small”, controller 114 determines a usable transmission method by selecting transmission method 6 from association table 1161 when the CPU utilization ratio acquired in operation S302 of FIG. 3 is “medium”, or by selecting transmission method 9 from association table 1161 when the CPU utilization ratio is “low” (in operation 514). Then, controller 114 shifts to operation S515.

After performing one of operations S511, S513, and S514, controller 114 generates creator information including parameters identifying the usable transmission method selected in one of operations S511, S513, and S514, and transmits the event information and the generated creator information to the intended monitoring terminal (in operation S515). Then controller 114 terminates the sequence of operations. Here, the event information transmitted in operation S515 indicates the fault event that has occurred in operation S301 of FIG. 3, and the creator information transmitted in operation S515 includes parameters identifying the usable transmission method selected in one of operations S511, S513, and S514.

By repeating the sequence of operations depicted in FIGS. 3 to 5, server 110 is able to transmit, as information on the operational state of server 110, event information indicating a fault event to each of monitoring terminals, every time the fault event has occurred. Further, when transmitting event information, server 110 may notify each of the monitoring terminals, about the usable transmission method determined based on the current load information of server 110, at the same time.

Further, server 110 may be configured to allow backup server 130 to perform, on behalf of server 110, transmission of a response message (event information) that is to be transmitted in response to a request signal from monitoring terminals 121, 122 (the first type of monitoring terminals). Even in this case, server 110 may be configured to keep transmission of a response message that is to be transmitted in response to a request signal from central monitoring terminal 123 (the second type of monitoring terminal), thereby maintaining real-time performance of monitoring process invoked by central monitoring terminal 123 (the second type of monitoring terminal).

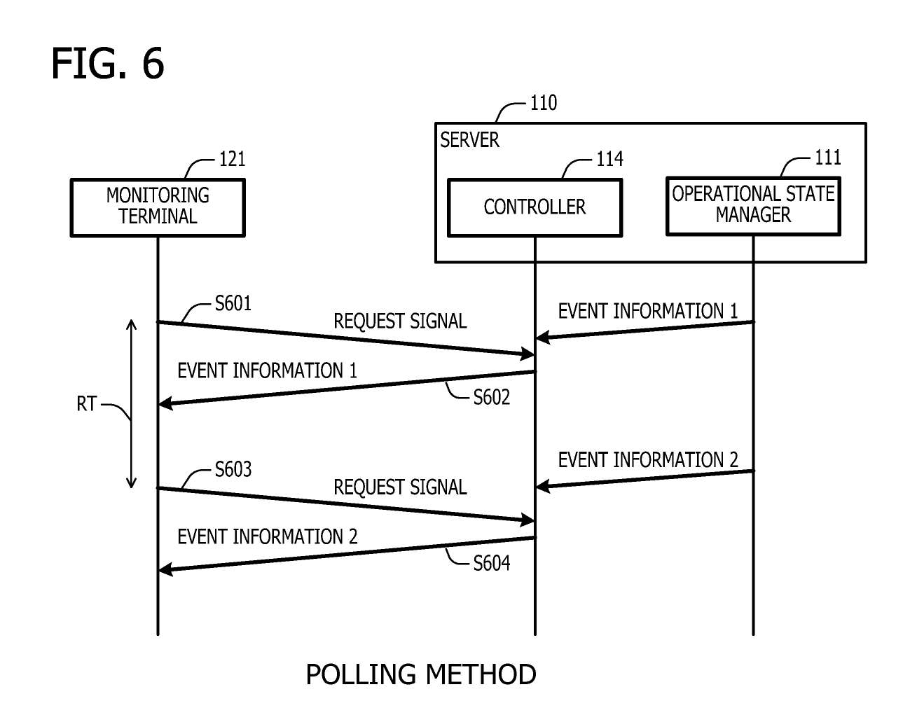

FIG. 6 is a diagram illustrating an example of a transmission sequence for monitoring operations performed using a polling method, according to an embodiment. Herein, description will be given of monitoring operations invoked by monitoring terminal 121, as an exemplary monitoring terminal. However, monitoring operations invoked by monitoring terminal 122 or central monitoring terminal 123 may be performed in a manner similar to those invoked by monitoring terminal 121. In the polling method, monitoring terminal 121 firstly transmits a request signal to server 110 (in operation S601) to establish a monitoring connection, between monitoring terminal 121 and server 110, for monitoring an operational state of server 110.

In the case, it is assumed that event information 1 is sent to controller 114 from operational state manager 111 of server 110. Controller 114 of server 110 transmits event information 1 received from operational state manager 111, to monitoring terminal 121 in response to the request signal transmitted from monitoring terminal 121 in operation S601 (in operation S602). Then, controller 114 disconnects the monitoring connection established between monitoring terminal 121 and server 110.

Next, monitoring terminal 121 transmits a next request signal to server 110 after request time RT has elapsed from previously transmitting the request signal in operation S601 (in operation S603) so as to establish a monitoring connection between monitoring terminal 121 and server 110.

Here, it is assumed that event information 2 has been already transmitted from operational state manager 111 of server 110 to controller 114. Then, controller 114 of server 110 transmits event information 2 received from operational state manager 111, to monitoring terminal 121, in response to the request signal that was transmitted from monitoring terminal 121 in operation S603 (in operation S604). Here, at the same time, the monitoring connection established between monitoring terminal 121 and server 110 is disconnected.

In this way, according to a polling method, a request signal is transmitted from monitoring terminal 121 to server 110 at predetermined time intervals, and every time a request signal is transmitted from terminal 121 to server 110, server 110 transmits the event information to monitoring terminal 121 when there exists at least one piece of event information received from operational state manager 111. For example, a polling method may be implemented by setting, to creator information that is transmitted from server 110 to a monitoring terminal, parameters in which request timer RT is set at a value greater than “0 [ms]” and connection status CS is set at “disconnected”.

In a polling method, the longer is request time RT at which request signals are transmitted from a monitoring terminal, the longer is a time lag from an occurrence of a fault event until transmission of event information indicating the occurred fault event to the monitoring terminal, thereby reducing real-time performance of monitoring the operational state of server 110. Meanwhile, in a polling method, the shorter is request time RT at which request signals are transmitted from a monitoring terminal, the greater is the magnitude of load currently being imposed on server 110 and a network, regardless of an occurrence of a fault event.

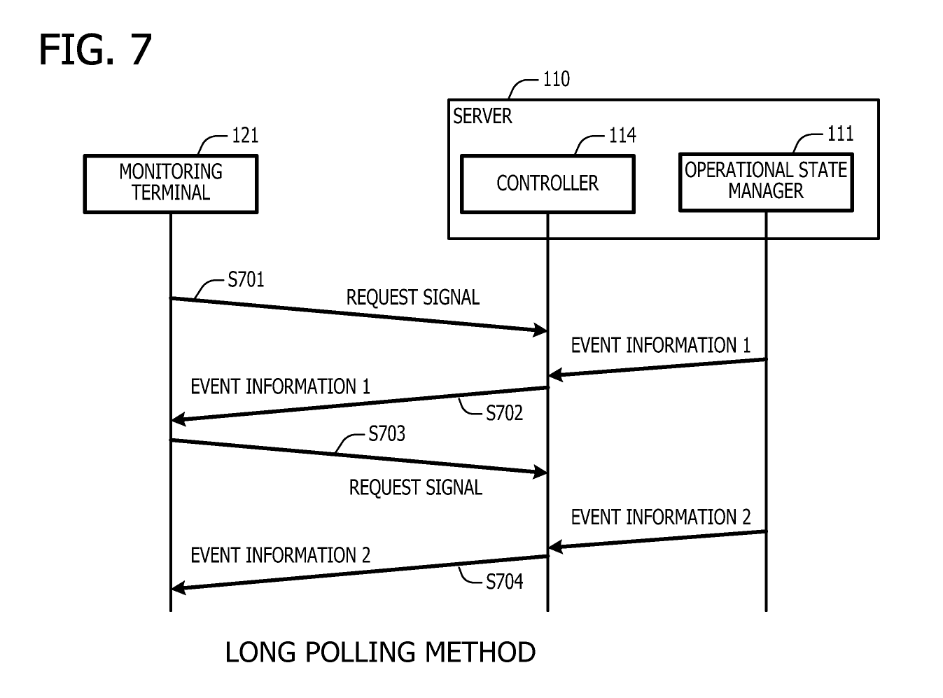

FIG. 7 is a diagram illustrating an example of a transmission sequence for monitoring operations performed using a long polling method, according to an embodiment. Herein, description will be given of monitoring operations invoked by monitoring terminal 121, as an exemplary monitoring terminal. However, monitoring operations invoked by monitoring terminal 122 or central monitoring terminal 123 may be performed in a manner similar to those invoked by monitoring terminal 121. In the long polling method, monitoring terminal 121 firstly transmits a request signal to server 110 (in operation S701) so as to establish a monitoring connection, between monitoring terminal 121 and server 110, for monitoring an operational state of server 110.

Controller 114 of server 110 waits for reception of event information 1 from operational state manager 111, and upon receiving event information 1 from operational state manager 111, controller 114 transmits event information 1 to monitoring terminal 121 in response to the request signal that was received in operation S701 (in operation S702). Here, at the same time, the monitoring connection established between monitoring terminal 121 and server 110 in operation S701 is disconnected.

Monitoring terminal 121, upon receiving event information 1 in operation S702, immediately transmits a request signal to server 110 (in operation S703) so as to establish a monitoring connection between monitoring terminal 121 and server 110.

Next, controller 114 of server 110, upon receiving the request signal from monitoring terminal 121, waits for reception of event information 2 from operational state manager 111, and upon receiving event information 2 from operational state manager 111, controller 114 transmits the received event information 2 to monitoring terminal 121 in response to the request signal that was received in operation S703 (in operation S704). Here, at the same time, the monitoring connection established between monitoring terminal 121 and server 110 in operation S703 is disconnected.

As mentioned above, in a long polling method, a monitoring connection for transmitting event information is firstly established, and event information is transmitted via the established monitoring connection when an event has occurred. When the transmission of the event information is completed, the monitoring connection is disconnected temporarily, and a next request signal is transmitted from monitoring terminal 121 to server 110. A long polling method may be implemented, for example, by setting, to creator information that is transmitted from server 110 to a monitoring terminal, parameters in which request time RT is set at “0” and connection status CS is set at “disconnected”.

In a long polling method, when plural fault events are occurring in a congested state, establishment of a monitoring connection and disconnection of the established monitoring connection are caused frequently, thereby increasing processing load of server 110. As a result, scalability for the number of fault events to be processed in a unit of time may become low when using the long polling method.

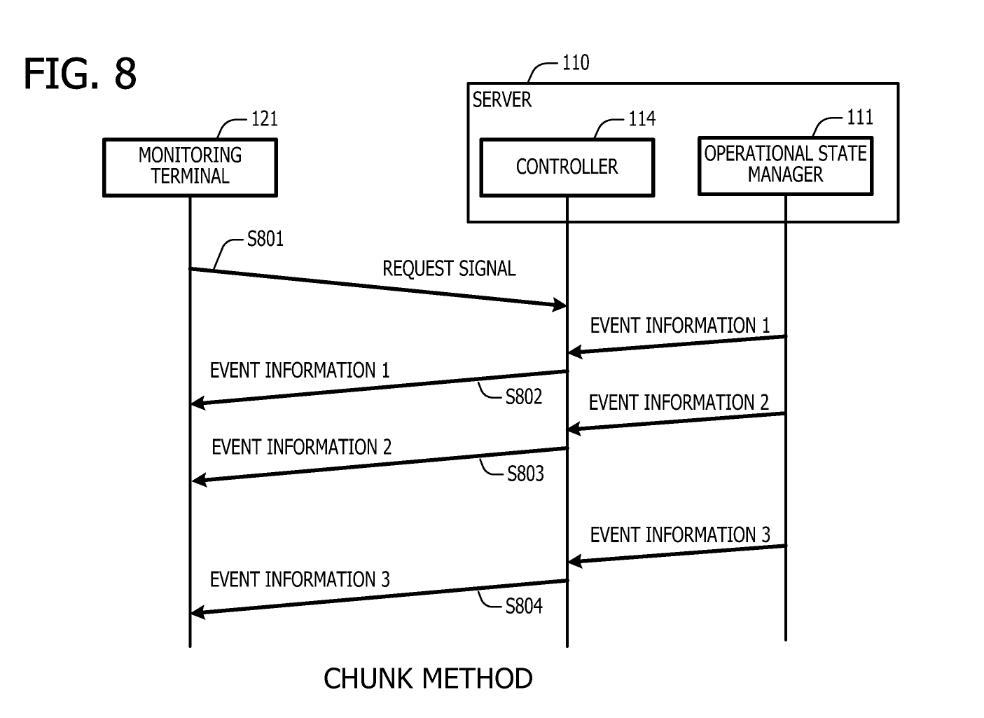

FIG. 8 is a diagram illustrating an example of a transmission sequence for monitoring operations performed using a chunk method, according to an embodiment. Herein, description will be given of monitoring operations invoked by monitoring terminal 121, as an exemplary monitoring terminal. However, monitoring operations invoked by monitoring terminal 122 or central monitoring terminal 123 may be performed in a manner similar to those invoked by monitoring terminal 121. In the chunk method, firstly, monitoring terminal 121 transmits a request signal to server 110 (in operation S801) to establish a monitoring connection, between monitoring terminal 121 and server 110, for monitoring an operational state of server 110.

Controller 114 of server 110 waits for receiving event information 1 from operational state manager 111, and upon receiving event information 1 from operational state manager 111, controller 114 transmits event information 1 to monitoring terminal 121 via the monitoring connection that was established in operation S801 (in operation S802). Here, controller 114 keeps the monitoring connection in a connected state even after completing transmission of event information 1, which is different from a polling method or a long polling method.

Next, controller 114 of server 110 waits for receiving event information 2 from operational state manager 111, and upon receiving event information 2 from operational state manager 111, controller 114 transmits event information 2 to monitoring terminal 121 via the monitoring connection that was established in operation S801 (in operation S803). Controller 114 keeps the monitoring connection to monitoring terminal 121 in a connected state even after completing transmission of event information 2, and transmits event information without waiting for receiving a next request signal.

Next, controller 114 of server 110 waits for receiving event information 3 from operational state manager 111, and upon receiving event information 3 from device status manager 111, controller 114 transmits event information 3 to monitoring terminal 121 via the monitoring connection that was established in operation S801 (in operation S804). Controller 114 keeps the monitoring connection to monitoring terminal 121 in a connected state even after completing transmission of event information 3.

As mentioned above, in a chunk method, a monitoring connection for transmitting information on an operational state of server 110 (for example, event information) is firstly established, and event information is transmitted via the established monitoring connection when an event has occurred. Further, even after completing transmission of the event information, the monitoring connection is kept in a connected state, and it is unnecessary to transmit a next request signal from monitoring terminal 121 to server 110. A chunk method may be implemented, for example, by setting, to creator information that is to be transmitted from server 110 to a monitoring terminal, parameters in which request time RT is set at “0” and connection status CS is set at “connected”.

In a chunk method, since a monitoring connection for transmitting event information is kept in a connected state, even when there are no fault events occurring, there may be redundant processing executed for keeping the monitoring connection in a connected state. Further, when the monitoring connection for transmitting event information has been broken off, a server may fall in an operational state in which server 110 is unable to transmit event information to a monitoring terminal even if a fault event has occurred in server 110.

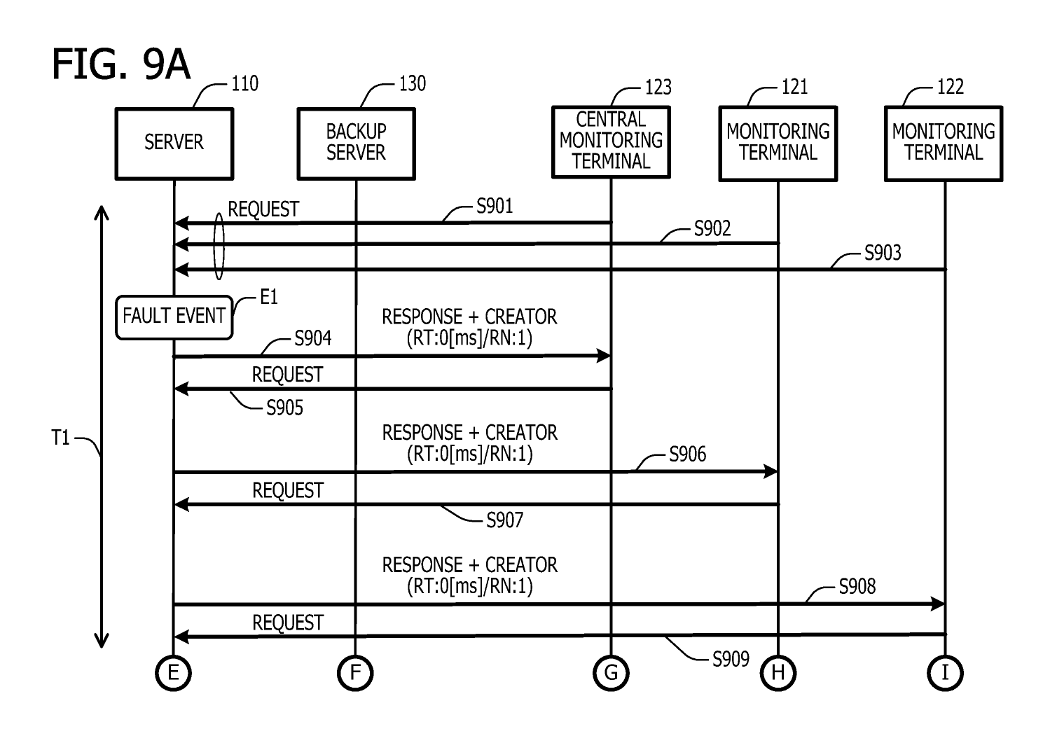

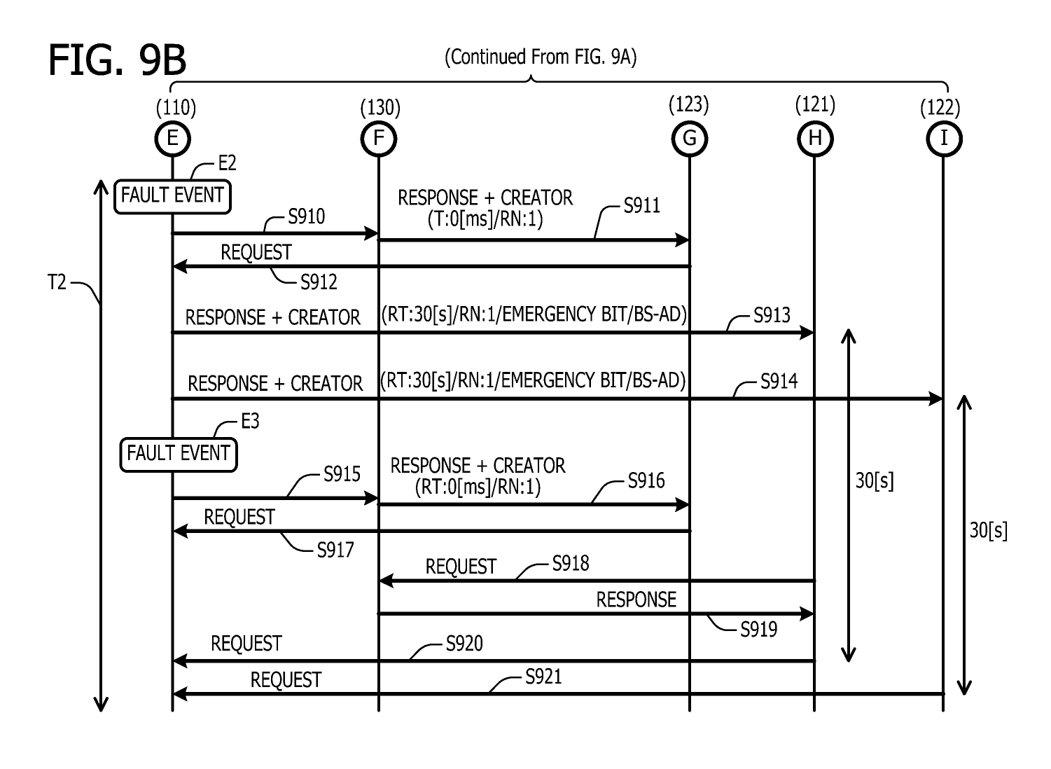

FIGS. 9A, 9B are diagrams illustrating an example of a transmission sequence for monitoring operations performed in a communication system, according to an embodiment. In the case, it is assumed that server 110 is operated in a state of low processing load (for example, a CPU utilization ratio is “low”, and a residual event Q count is “small”) during time period T1. It is also assumed that server 110 is operated in a state of high processing load (for example, a CPU utilization ratio is “high”, and a residual event Q count is “large”) during time period T2 after a lapse of time period T1. In FIGS. 9A, 9B, “RESPONSE” means a response message that includes information on an operational state of server 110, for example, event information, and “CREATOR” means creator information including parameters identifying the determined usable transmission method.

Further, it is assumed that monitoring operations according to a long polling method (for example, as depicted in FIG. 7) are performed during time period T1. First, monitoring terminals 121, 122 and central monitoring terminal 123 transmit request signals for acquiring information on an operating state of server 110 (in operations S901 to S903). Next, it is assumed that fault event E1 has occurred in server 110.

Since server 110 has already received a request signal from central monitoring terminal 123 in operation S901, server 110 transmits creator information and a response message (including information on the operational state of server 110) to central monitoring terminal 123 (in operation S904). Here, event information indicating an occurrence of fault event E1 is included, as information on the operational state of server 110, in the response message that is transmitted in operation S904. Further, because server 110 is being operated in a state of low processing load, the creator information that is transmitted in operation S904 includes parameters in which request time RT is set at value “0 [ms]” and request number RN is set at value “1”.

Upon receiving the creator information in operation S904, central monitoring terminal 123 immediately transmits a request signal to server 110, only once without waiting time (in operation S905). At the same time, central monitoring terminal 123 performs processing on the event information that was transmitted from server 110 in operation S904 (for example, displaying the event information to a user).

Next, in response to the request signal that was received from monitoring terminal 121 in operation S902, server 110 transmits creator information and a response message to monitoring terminal 121 (in operation S906). Here, the event information indicating an occurrence of fault event E1 is included in the response message that is transmitted in operation S906. Further, since server 110 is being operated in a state of low processing load during time period T1, the creator information that is transmitted in operation S906 may include parameters in which request time RT is set at value “0” and request number RN is set at value “1”.

In response to the creator information that was received in operation S906, monitoring terminal 121 immediately transmits a request signal to server 110, only once without waiting time (in operation S907). At the same time, monitoring terminal 121 performs processing on the event information that was transmitted from server 110 in operation S906 (for example, displaying the event information to a user).

Next, in response to the request signal that was received from monitoring terminal 122 in operation S903, server 110 transmits creator information and a response message to monitoring terminal 122 (in operation S908). Here, the event information indicating an occurrence of fault event E1 is included in the response message that is transmitted in operation S908. Further, since server 110 is being operated in a state of low processing load during time period T1, the creator information that is transmitted in operation S908 may include parameters in which request time RT is set at value “0[ms]” and request number RN is set at value “1”.

In response to the creator information that was received in operation S908, monitoring terminal 122 immediately transmits a request signal to server 110, only once without waiting time (in operation S909). At the same time, monitoring terminal 122 performs processing on the event information that was transmitted from server 110 in operation S908 (for example, displaying the event information to a user).

Next, it is assumed that new fault event E2 has occurred in server 110. Then, since server 110 has already received a request signal from central monitoring terminal 123 in operation S905, server 110 transmits creator information and a response message to central monitoring terminal 123 (in operation S910). Here, event information indicating an occurrence of fault event E2 is included in the response message that is transmitted in operation S910, and the creator information that is transmitted in operation S910 includes parameters in which request time RT is set at value “0[ms]” and request number RN is set at value “1”. Further, in operation S910, since server 110 is being operated in a state of high processing load during time period T2 and the request signal has been originated from central monitoring terminal 123, server 110 transmits creator information and a response message, not to central monitoring terminal 123, but to backup server 130.

Then backup server 130 transfers the creator information and the response message that was transmitted in operation S910, to central monitoring terminal 123 (in operation S911). At the same time, backup server 130 stores the event information included in the response message that was received in operation S910. Next, central monitoring terminal 123 immediately transmits a request signal to server 110, using a usable transmission method notified by the creator information that was received in operation S911 (in operation S912). At the same time, central monitoring terminal 123 performs processing on the event information that was received in operation S911 (for example, displaying the event information to a user).

Next, since server 110 has already received a request signal from monitoring terminal 121 in operation S907, server 110 transmits creator information and a response message to monitoring terminal 121 (in operation S913). Here, the response message that was transmitted in operation S913 includes event information indicating an occurrence of fault event E2.

In the case, since server 110 is operated in a state of high processing load, the creator information that was transmitted in operation S913 includes parameters in which request interval RT is set at “30[s]”, request number RN is set at “1”, an emergency bit is set at “ON”, and an address of backup server 130 is set at “BS-AD”. Monitoring terminal 121 set timer value “30[s]” to a timer based on the parameters (request time RT is set at “30 [s]”) included in the creator information received in operation S913.

Next, since server 110 has already received a request signal from monitoring terminal 122 in operation S909, server 110 transmits creator information along with a response message to monitoring terminal 122 (in operation S914). Here, the response message that was transmitted in operation S914 includes event information indicating an occurrence of fault event E2.

In the case, since server 110 is being operated in a state of high processing load, the creator information that was transmitted in operation S914 includes parameters in which request interval RT is set at “30 [s]”; request number RN is set at “1”, an emergency bit is set at “ON”, and the address of backup server 130 is set at “BS-AD”. Monitoring terminal 122 set timer value “30[s]” to a timer based on the parameter (request time RT is set at “30[s]”) included in the creator information that was received in operation S914.

Next, it is assumed that new fault event E3 has occurred in server 110. Then, since server 110 has already received a request signal from central monitoring terminal 123 in operation S912, server 110 transmits creator information and a response message (in operation S915). Here, the response message that is transmitted in operation S915 includes event information indicating an occurrence of fault event E3, and the creator information that is transmitted in operation S915 includes parameters in which request time RT is set at “0[ms]” and request number RN is set at “1”. Further, since server 110 is being operated in a state of high processing load and the request signal has been transmitted from the predetermined central monitoring terminal 123, in operation S915, creator information and a response message are firstly transmitted to backup server 130, but not to central monitoring terminal 123.

Next, backup server 130 transfers the creator information and the response message that were received in operation S915 to central monitoring terminal 123 (in operation S916). At the same time, backup server 123 stores the event information included in the received response message. Next, central monitoring terminal 123 transmits a request signal to server 110, only once without waiting time, based on the usable transmission method identified by the creator information that was received in operation S916 (in operation S917). At the same time, central monitoring terminal 123 performs processing on the event information that was received in operation S916 (for example, displaying the event information to a user).

Next, since the creator information that was received in operation S913 includes emergency bit with value “ON”, monitoring terminal 121 transmits a request signal to backup server 130, but not to server 110, using address information of backup server 130 contained in the creator information (in operation S918). Backup server 130, upon receiving the request signal that was transmitted in operation S918, transmits a response message to monitoring terminal 121 (in operation S919). Here, the response message that is transmitted in operation S919 includes the event information that was receive from server 110 and stored in backup server 130. In the case, the event information includes, for example, information on occurrences of fault events E2, E3.

Next, in monitoring terminal 121, it is assumed that the timer, to which an expiration time of “30[s]” was set by monitoring terminal 121 in operation S913, has expired. Then, monitoring terminal 121 transmits a request signal to server 110, only once in response to the creator information that was received in operation S913 (in operation S920). Similarly, in monitoring terminal 122, it is assumed that the timer, to which an expiration time of “30[s]” was set by monitoring terminal 122 in operation S914, has expired. Then monitoring terminal 122 transmits a request signal to server 110, only once in response to the creator information that was received in operation S914 (in operation S921).

As described above, in communication system 100 according to the embodiment, a usable transmission method, by which a request signal and information on the operational state of server 110 are transmitted between server 110 and monitoring terminals 121, 122, and central monitoring terminal 123, may be determined based on a load condition under which server 110 is being operated. Each of monitoring terminals is informed of the determined usable transmission method, thereby performing an efficient monitoring of the operational state of server 110 using the informed usable transmission method.

For example, when server 110 is being operated under a relatively high processing load, an extra processing load that is caused by monitoring operations for server 110 and is imposed on server 110, may be reduced using, for example, a polling method in which request time RT is set at relatively large value. This may prevent server 110 from falling in an operating state in which, for example, server 110 is unable to perform data transmission, thereby failing to be monitored properly by monitoring terminals.

Meanwhile, when server 110 is being operated under a relatively low processing load, real-time performance of monitoring operations for server 110 may be improved using, for example, a long polling method or a chunk method. It is also possible to use a polling method in which request time RT is set at a relatively small value when server 110 is being operated under a relatively low processing load. In this case, time lag from an occurrence of a fault event to transmission of event information indicating the occurrence of the fault event to a monitoring terminal may be reduced, thereby improving real-time performance of monitoring operations for server 110.

In another case, for example, by applying server 110 according to the embodiment to a radio base station, an operational state of the radio base station may be remotely monitored while controlling an increase in processing load of the radio base station. This allows remote maintenance of the radio base station in such a way that an operational state of the radio base station is monitored remotely while controlling influence of the radio base station on call processing invoked by a mobile station.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. An apparatus for transmitting information on an operational state to a monitoring terminal, the apparatus comprising:
a resource manager configured to acquire current load information including at least one current load value each indicating magnitude of a type of load that is currently imposed on the apparatus;
a receiver configured to receive a request signal from the monitoring terminal;
a transmitter configured to transmit information on the operational state of the apparatus to the monitoring terminal after the receiver received the request signal from the monitoring terminal;
a determiner configured to determine a usable transmission method that is to be used for receiving the request signal and transmitting information on the operational state of the apparatus, based on the current load information acquired by the resource manager; and
a notifier configured to notify the monitoring terminal about the determined usable transmission method, wherein
the receiver receives the request signal from the monitoring terminal using the determined usable transmission method, and
the transmitter transmits information on the operational state of the apparatus to the monitoring terminal using the determined usable transmission method.

2. The apparatus of claim 1, further comprising
an association table for storing information associating load information with one or more transmission methods, the load information including first load ranges each being a range of a first load value indicating magnitude of a first type of load that is imposable on the apparatus, wherein
each of the first load ranges is associated with one of the one or more transmission methods that is to be used when the apparatus is being operated under a load condition in which a first current load value is staying within the each of the first load ranges, the first current load value indicating magnitude of the first type of load that is currently imposed on the apparatus, and
the determiner determines the usable transmission method based on the association table by selecting, from among the one or more transmission methods, a transmission method that is associated with one of the first load ranges that contains the first current load value.

3. The apparatus of claim 2, wherein
the association table associates the first load ranges with the one or more transmission methods such that the higher is the first load value, the smaller is magnitude of the first type of load caused by a transmission method associated with one of the first load ranges that contains the first load value.

4. The apparatus of claim 1, wherein when predetermined one of the at least one current load value exceeds a threshold value,
the transmitter transmits information on the operational state of the apparatus to an another apparatus, and
the notifier notifies the monitoring terminal about address information of the another apparatus and instruction information for instructing the monitoring terminal to switch a destination of the request signal from the apparatus to the another apparatus so that the monitoring terminal is able to transmit the request signal to the another apparatus instead of the apparatus.

5. The apparatus of claim 2, wherein
the load information further includes second load ranges each being a range of a second load value indicating magnitude of a second type of load that is imposable on the apparatus,
the association table stores information for associating, as the load information, range combinations of the first load ranges and the second load ranges with the one or more transmission methods,
each of the range combinations is associated with a transmission method to be used when the apparatus is being operated under a load condition in which the first current load value is staying within a first load range of the each of the range combinations and a second current load value is staying within a second load range of the each of the range combinations, the second current load value indicating magnitude of the second type of load that is currently imposed on the apparatus, and
the determiner determine the usable transmission method based on the association table by selecting, from among the one or more transmission methods, a transmission method that is associated with one of the range combinations that contains the first current load value and the second current load value.

6. The apparatus of claim 2, wherein
each of the one or more transmission methods is identified by one or more parameters, and
the each of the first load ranges is associated with the one or more parameters identifying one of the one or more transmission methods that is to be used when the apparatus is being operated under a load condition in which the first current load value is staying within the each of the first load ranges.

7. The apparatus of claim 6, wherein
the one or more parameters include a request time defined as a time interval at which transmission of the request signal from the monitoring terminal to the apparatus is repeated using the usable transmission method.

8. The apparatus of claim 6, wherein
the one or more parameters include a connection status defined as information indicating whether a connection for monitoring the operational state of the apparatus is disconnected or kept connected after the apparatus has transmitted information on the operational state of the apparatus to the monitoring terminal, and
when the connection is kept connected, the apparatus transmits next information on the operational state of the apparatus to the monitoring terminal using the usable transmission method, before receiving a next request signal after transmitting first information on the operational state of the apparatus.

9. The apparatus of claim 6, wherein
the one or more parameters includes a request number defined as the number of times of transmitting the request signal from the monitoring terminal to the apparatus using the usable transmission method.

10. The apparatus of claim 1, wherein
the determiner determines the usable transmission method based on both a type of the monitoring terminal and the current load information of the apparatus.

11. A system comprising:
a communication apparatus configured to acquire current load information including at least one current load value, each of the at least one current load value indicating magnitude of a type of load that is currently imposed on the communication apparatus;
a monitoring terminal configured to transmits, to the communication apparatus, a request signal for acquiring information on an operational state of the communication apparatus, wherein
the communication apparatus determine a usable transmission method that is to be used for receiving the request signal and transmitting information on the operational state of the apparatus, based on the acquired current load information of the communication apparatus,
the communication apparatus notifies the monitoring terminal about the determined usable transmission method,
the monitoring terminal transmits the request signal to the communication apparatus using the usable transmission method notified by the communication apparatus, and
the communication apparatus transmits information on the operational state of the communication apparatus to the monitoring terminal using the usable transmission method, after receiving the request signal from the monitoring terminal.

12. A method for monitoring an operational state of a communication apparatus using a monitoring terminal, the method comprising:
providing the communication apparatus with one or more transmission methods;
acquiring, by the communication apparatus, current load information including at least one current load value, each of the at least one current load value indicating magnitude of a type of load that is currently imposed on the communication apparatus;
determining, by the communication apparatus, a usable transmission method that is to be used for receiving the request signal and transmitting information on the operational state of the communication apparatus, based on the acquired current load information of the communication apparatus;
notifying, by the communication apparatus, the monitoring terminal about the determined usable transmission method;
receiving, by the communication apparatus, the request signal from the monitoring terminal using the determined usable transmission method; and
transmitting, by the communication apparatus, the operational state of the communication apparatus to the monitoring terminal using the determined usable transmission method, after receiving the request signal from the monitoring terminal.
